(19) United States
(12) Patent Application Publication
(10) Pub. No.: US 2010/0162410 A1
(43) Pub. Date: Jun. 24, 2010

(54) DIGITAL RIGHTS MANAGEMENT (DRM) CONTENT PROTECTION BY PROXY TRANSPARENCY CONTROL

(75) Inventors: David D. Chudy, Raleigh, NC (US); Michael G. Lisanke, Durham, NC (US); Cristian Medina, Durham, NC (US); William G. Pagan, Durham, NC (US)

Correspondence Address: CAREY, RODRIGUEZ, GREENBERG & PAUL, LLP;STEVEN M. GREENBERG, 950 PENINSULA CORPORATE CIRCLE, SUITE 2022, BOCA RATON, FL, 33487, US

(73) Assignee: INTERNATIONAL BUSINESS MACHINES CORPORATION, Armonk, NY (US)

(21) Appl. No.: 12/343,568

(22) Filed: Dec. 24, 2008

(51) Int. Cl. H04L 9/00

(52) U.S. Cl. 726/27

(57) ABSTRACT

Embodiments of the present invention provide a method, system and computer program product for protecting digital content through visual proxy transparency control. In an embodiment of the invention, a method for digital content access control for multi-party rights management can be provided. The method can include creating a transparent overlay window over a target window, identifying permissions associated with digital rights management (DRM) protected content rendered in the target window, intercepting in the transparent overlay window a user interface event for a portion of the target window displaying the DRM protected content, and quashing the user interface event if permissions associated with the DRM protected content do not allow access to the DRM protected content, but otherwise passing the event to an event handler for the target window.

### BACKGROUND OF THE INVENTION

1. Field of the Invention

The present invention relates to the field of digitally protected content and more particularly to protecting content by access control technology such as digital rights management.

2. Description of the Related Art

With the advent of digital distribution of media, computer programs, films, games, and music on the Internet, distributing an exact copy of digital content to millions of users has become an important aspect of electronic commerce. Some digital content can be commercially valuable content such as artwork or confidential property such as medical records. Although digital content owners usually welcome the widespread distribution of digital content, owners in some cases may wish to enforce limited control over the distribution and access to high-value digital content.

A number of access control technologies including digital rights management (DRM) technology can protect digital content. For example, content owners utilizing DRM technology can encrypt digital content to prevent users from copying or gaining unauthorized access to the protected content. Other DRM technologies apply watermarks to digital content to limit the redistribution of the protected content.

Message queuing enables applications running at different times to communicate across heterogeneous networks and systems that may be temporarily offline. Message queuing provides guaranteed message delivery, efficient routing, security, and priority-based messaging. It can be used to implement solutions for applications rendering DRM protected content.

Although current techniques of managing message queues for applications rendering DRM protected content have been employed, the customization of message filters to prevent specific application behavior remains to be a challenge. Since discovery of custom message filters is problematic, specific knowledge of application messaging is required to customize message filtering.

### BRIEF SUMMARY OF THE INVENTION

Embodiments of the present invention provide a method, system and computer program product for protecting digital content through visual proxy transparency control. In an embodiment of the invention, a method for digital content access control for multi-party rights management can be provided. The method can include creating a transparent overlay window over a target window, identifying permissions associated with DRM protected content rendered in the target window, intercepting in the transparent overlay window a user interface event for a portion of the target window displaying the DRM protected content, and quashing the user interface event if permissions associated with the DRM protected content do not allow access to the DRM protected content, but otherwise passing the event to an event handler for the target window.

In one aspect of the embodiment, the method can further include creating within the transparent overlay window an opaque section blocking a visual portion of the markup incorporating the hyperlink to the DRM protected content. In another aspect of the embodiment, the method can further include blocking application functions in an application rendering the DRM protected content in the target window based on the permissions.

In another embodiment of the invention, a data processing system can be configured for digital content access control for multi-party rights management. The system can include a visual proxy transparency control module configured for coupling to a content viewer executing in a host computing platform and displaying DRM protected content. The system also can include a transparent overlay window overlapping a target window for the content viewer. Importantly, the module can include program code enabled to identify permissions associated with the DRM protected content displayed in the target window, to intercept in the transparent overlay window a user interface event for a portion of the target window displaying the DRM protected content, and to quash the user interface event if permissions associated with the DRM protected content do not allow access to the DRM protected content, but otherwise to pass the user interface event to the target window.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for protecting digital content through visual proxy transparency control;

FIG. 2 is a schematic illustration of a DRM protected content rendering data processing system configured to protect digital content through visual proxy transparency control; and

FIG. 3 is a flow chart illustrating a process for protecting digital content through visual proxy transparency control.

### DETAILED DESCRIPTION OF THE INVENTION

Embodiments of the present invention provide a method, system and computer program product for protecting digital content through visual proxy transparency control. In accordance with an embodiment of the invention, a transparent overlay window can be created over a target window rendering DRM protected content. Thereafter, permissions associated with the DRM protected content can be identified. Finally, user interface events such as keyboard or mouse events can be intercepted in the transparent overlay window. Consequently, DRM permissions for the intercepted events can be consulted and, if the user interface event is allowed based upon the DRM permissions, then the event can be proxied through to an event handler for the target window. Otherwise, if the event is disallowed, then the user interface event intercepted in the transparent overlay window can be quashed.

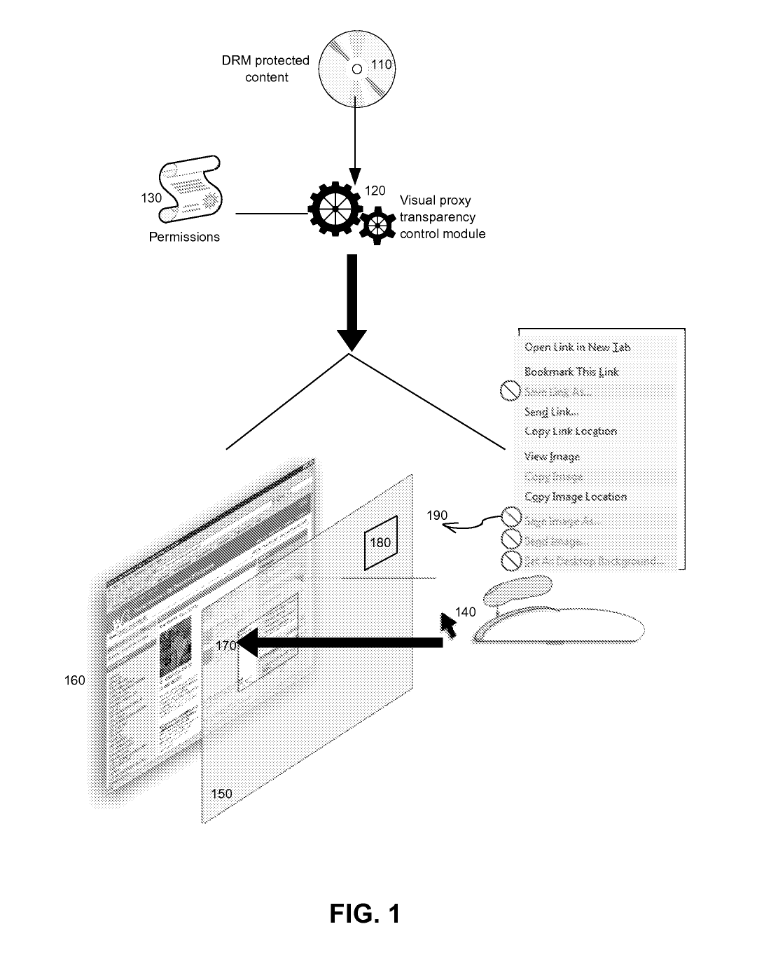

In illustration, FIG. 1 pictorially shows a process for protecting digital content through visual proxy transparency control. As shown in FIG. 1, digital content or DRM protected content 110 can be restricted by a visual proxy transparency control module 120. Specifically, a transparent overlay window 150 can overlap a target window 160 rendering DRM protected content 110, or rendering markup incorporating a hyperlink to DRM protected content 110. Thereafter, the visual proxy transparency control module 120 can intercept in the transparent overlay window 150, a user interface event 140, such as a keyboard or mouse event, directed to the target window 160. If DRM permissions 130 associated with the DRM protected content 110 do not allow access to the DRM protected content, then the visual proxy transparency control module 120 can quash the intercepted user interface event 140.

As such, based on DRM permissions 130 forbidding access to a user, the user can be visually blocked from accessing DRM protected content 110 through the strategic placement of the transparent overlay window 150. Optionally, in one aspect of the embodiment, based on DRM permissions 130, specified sections in the transparent overlay window 150 can be designated as opaque areas 180 or sheer areas 170 visually blocking access to the DRM protected content 110. For example, if a user attempts to “right-click” a DRM image rendered in a target window 160, a restricted menu of options may pop up visually blocking standard application functions 190 through icons, or graying-out application functions such as “save image as.”

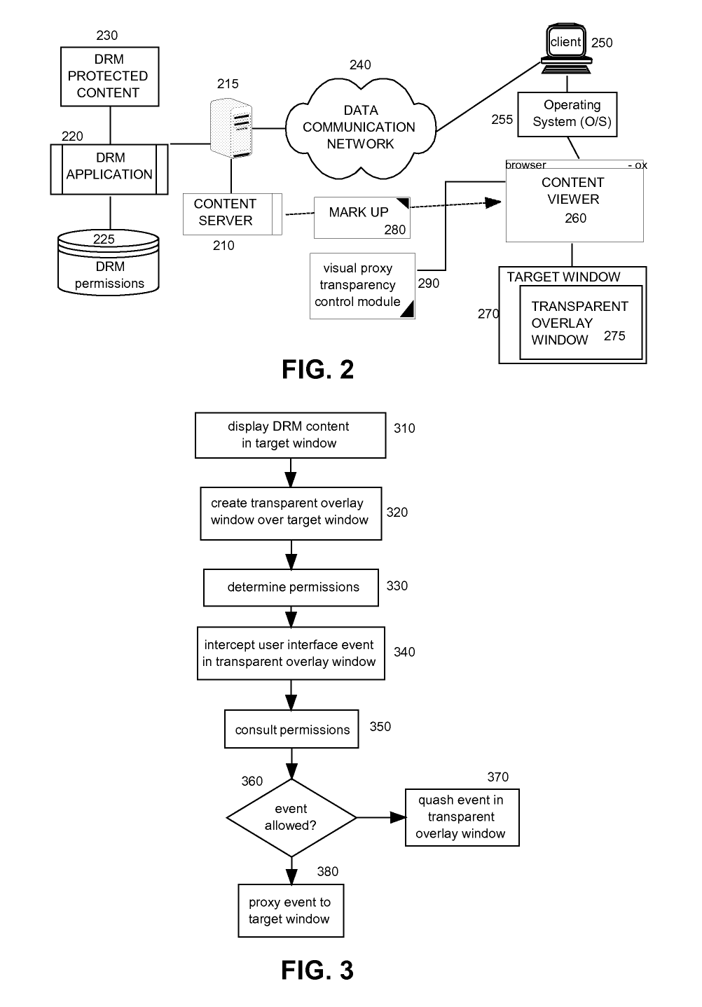

Of note, the process described in connection with FIG. 1 can be implemented in a DRM protected content rendering data processing system. In further illustration, FIG. 2 schematically shows a DRM protected content rendering data processing system configured to protect digital content through visual proxy transparency control. The system can include a host computing platform 215 supporting the operation of a content server 210. The host computing platform 215 also can host the execution of a DRM application 220 rendering DRM protected content 230 and corresponding DRM permissions 225 to a client system 250 over a data communications network 240. The client system 250 can host an operating system 255 executing a content viewer 260. The content viewer 260 can display DRM protected content 230 in a target window 270 having a transparent overlay window 275 overlapping the target window 270 fully or partially. Alternatively, the content viewer 260 can preferably render markup 280 incorporating a hyperlink to the DRM protected content 230 in the target window 270.

Furthermore, a visual proxy transparency control module 290 coupled to the content viewer 260 can include program code enabled to identify DRM permissions 225 associated with the DRM protected content 230, create a transparent overlay window 275 over the target window 270, intercept in the transparent overlay window 275 a user interface event for the DRM protected content 230, or for the markup 280 in connection with the DRM protected content. If the DRM permissions 225 associated with the DRM protected content 230 do not allow access to the DRM protected content 230, then the program code can be enabled to quash the user interface event. The program code can further be enabled to selectively display DRM protected content 230 by creating a sheer and/or opaque area within the transparent overlay window.

Notably, the module 290 can include program code enabled to render DRM protected content on any non-DRM player as along as the player is compatible with the content. The module 290 can supplement any access control technology by visual training of enforcement of DRM constraints on a particular application rendering protected content. The visual training can include GUI message blocking via visual programming, essentially identifying sections of content to be selectively omitted from viewing based on DRM permissions 225 of the DRM protected content 230.

In yet further illustration, FIG. 3 is a flow chart illustrating a process for protecting digital content through visual proxy transparency control. The process can begin in block 310 with rendering DRM protected content or rendering markup referencing DRM protected content in a target window. Next, in block 320, a transparent overlay window can be created over the target window rendering DRM protected content. In block 330, permissions associated with the DRM protected content can be determined. In block 340, a keyboard or mouse event can be intercepted in the transparent overlay window for the markup in connection with the DRM protected content. Next in block 350, DRM permissions for the attempted event can be consulted. In decision block 360, if the event is allowed based on the DRM permissions associated with the DRM protected content allowing access, then the event can be proxied through the target window in block 380. If the event is disallowed, then the event can be quashed and the user will not be able to accomplish the desired user interface event in block 370.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for digital content access control for multi-party rights management comprising:
creating a transparent overlay window over a target window;
identifying permissions associated with digital rights management (DRM) protected content rendered in the target window;
intercepting in the transparent overlay window a user interface event for a portion of the target window displaying the DRM protected content; and
quashing the user interface event if permissions associated with the DRM protected content do not allow access to the DRM protected content, but otherwise passing the event to an event handler for the target window.

2. The method of claim 1, further comprising creating within the transparent overlay window an opaque section blocking a visual portion of the markup incorporating the hyperlink to the DRM protected content.

3. The method of claim 1, further comprising blocking application functions in an application rendering the DRM protected content in the target window based on the permissions.

4. A data processing system configured for digital content access control for multi-party rights management comprising:
a visual proxy transparency control module configured for coupling to a content viewer executing in a host computing platform and displaying digital rights management (DRM) protected content; and,
a transparent overlay window overlapping a target window for the content viewer,
the module comprising program code enabled to identify permissions associated with the DRM protected content displayed in the target window, to intercept in the transparent overlay window a user interface event for a portion of the target window displaying the DRM protected content, and to quash the user interface event if permissions associated with the DRM protected content do not allow access to the DRM protected content, but otherwise to pass the user interface event to the target window.

5. A computer program product comprising a computer usable medium embodying computer usable program code for digital content access control for multi-party rights management, the computer program product comprising:
computer usable program code for creating a transparent overlay window over a target window;
computer usable program code for identifying permissions associated with digital rights management (DRM) protected content rendered in the target window;
computer usable program code for intercepting in the transparent overlay window a user interface event for a portion of the target window displaying the DRM protected content; and
computer usable program code for quashing the user interface event if permissions associated with the DRM protected content do not allow access to the DRM protected content, but otherwise passing the event to an event handler for the target window.

6. The computer program product of claim 5 further comprising computer usable program code for creating within the transparent overlay window an opaque section blocking a visual portion of the rendered markup incorporating the hyperlink to the DRM protected content.

7. The computer program product of claim 5 further comprising computer usable program code for blocking application functions in an application rendering the DRM protected content based on the permissions.
